(19) United States
(12) Patent Application Publication
(10) Pub. No.: US 2026/0125525 A1
(43) Pub. Date: May 7, 2026

(54) POLYIMIDE FILM AND LAMINATE BOARD INCLUDING THE SAME

(71) Applicant: TAIMIDE TECHNOLOGY INCORPORATION, Hsinchu Hsien (TW)

(72) Inventors: TING-I LIU, Hsinchu Hsien (TW); YI-HSUEH HO, Hsinchu Hsien (TW); YUNG-CHU CHUANG, Hsinchu Hsien (TW); CHUNG-YI CHEN, TAOYUAN CITY (TW); HSIN-EN HUANG, TAOYUAN CITY (TW)

(73) Assignee: TAIMIDE TECHNOLOGY INCORPORATION, Hsinchu Hsien (TW)

(21) Appl. No.: 18/937,066

(22) Filed: Nov. 5, 2024

(51) Int. Cl. C08J 5/18; C08J 3/28; C08J 7/04

(52) U.S. Cl. CPC C08J 5/18; C08J 3/28; C08J 7/04; C08J 2379/08

(57) ABSTRACT

Provides a polyimide film and a laminate board thereof, in particular a polyimide film, which includes a 3,3′,4,4′-biphenyltetracarboxylic dianhydride (BPDA) component; a pyromellitic dianhydride (PMDA) component; a p-phenylenediamine (p-PDA) component; a 2,2′-dimethyl-4,4′-diaminobiphenyl (m-TB) component and a 4,4′-oxydianiline (ODA) component; and uses BPDA and p-PDA as the copolymerized segments. The polyimide film and the laminate board including the polyimide film have good thermal properties, mechanical properties and adhesion.

### BACKGROUND OF THE INVENTION

### 1. Field of the Invention

The present disclosure relates to a polyimide film and a laminate board including the polyimide film, and in particular to a polyimide film, which includes a 3,3′,4,4′-biphenyltetracarboxylic dianhydride (BPDA) component; a pyromellitic dianhydride (PMDA) component; a p-phenylenediamine (p-PDA) component; a 2,2′-dimethyl-4,4′-diaminobiphenyl (m-TB) component and a 4,4′-oxydianiline (ODA) component; and uses BPDA and PDA as copolymer segments. The polyimide film and the laminate board including the polyimide film have good thermal properties, mechanical properties and adhesion.

### 2. Description of the Related Art

Flexible circuit board is a laminate containing a metal layer and a polyimide film. Most flexible circuit boards have an adhesive layer between the metal layer and the polyimide film so as to be the medium between the two layers. In recent years, the design of flexible circuit boards has been trending toward thinner lines, and the thickness of the metal layer has become thinner and thinner. Therefore, a laminate in which a polyimide film is directly bonded to a metal layer has been developed.

Generally speaking, when a polyimide film is bonded to a metal layer, a plastic polyimide layer can be attached to the polyimide film as a bonding medium. However, during the bonding process with the metal layer, it needs to go through the production method using high-temperature hot pressing, so it is difficult to produce a laminate of a polyimide film and a metal layer that has a relatively thin thickness. Another way is to use direct metallization to the bonding of the metal layer and the polyimide film. However, it is difficult for common polyimide to produce adhesion with the metal layer, and the surface treatment before metallization is required to achieve a certain degree of adhesion between polyimide and metal.

TWI695865 proposes a method for improving the adhesion after metallization. The method is to apply a layer of primer on the polyimide film to improve the adhesion between the metal layer and the polyimide film.

### BRIEF SUMMARY OF THE INVENTION

However, the inventors found that due to the poor thermal properties of the primer coating, the thermal properties of the overall polyimide film will be reduced, and the primer layer will easily stick, causing problems in subsequent processing.

Therefore, the present disclosure proposes a polyimide film that can provide good adhesion without the need for a primer coating, effectively improves its adhesion after metallization, and can still maintain an adhesive force of greater than 0.5 kgf/cm after baking at 150° C. for 24 hours.

The present disclosure provides a polyimide film, which includes a copolymerized polyimide formed from a dianhydride and a diamine. The dianhydride includes 60 to 80 mol % of 3,3′,4,4′-biphenyltetracarboxylic dianhydride (BPDA) and 20 to 40 mol % of pyromellitic dianhydride (PMDA), based on a total mole number of the dianhydride. The diamine includes 10 to 40 mol % of p-phenylenediamine (p-PDA), 30 to 60 mol % of 2,2′-dimethyl-4,4′-diaminobiphenyl (m-TB), and 10 to 40 mol % of 4,4′-oxydianiline (ODA), based on a total mole number of the diamine. The copolymerized polyimide includes 25 to 40% of a copolymerized segment composed of 3,3′,4,4′-biphenyltetracarboxylic dianhydride (BPDA) and p-phenylenediamine (p-PDA), based on a total mole number of the copolymerized polyimide. Further, the polyimide film has a linear coefficient of thermal expansion CTE of less than 15 ppm/° C. and a Young's modulus of greater than 7 GPa.

### DETAILED DESCRIPTION OF THE INVENTION

### Preparation of Polyimide Film

The polyimide film is produced by chemical cyclization or thermal cyclization of copolymerized polyamic acid, which is obtained by polymerization of a dianhydride and a diamine. The dianhydride includes 60 to 80 mol % of 3,3′,4,4′-biphenyltetracarboxylic dianhydride (BPDA) and 20 to 40 mol % of pyromellitic dianhydride (PMDA), based on a total mole number of the dianhydride. The diamine includes 10 to 40 mol % of p-phenylenediamine (p-PDA), 30 to 60 mol % of 2,2′-dimethyl-4,4′-diaminobiphenyl (m-TB), and 10 to 40 mol % of 4,4′-oxydianiline (ODA), based on a total mole number of the diamine. The copolymerized polyimide includes a copolymerized segment composed of 3,3′,4,4′-biphenyltetracarboxylic dianhydride (BPDA) and p-phenylenediamine (p-PDA).

The implementation uses BPDA and PDA to react in a solvent for 1 to 3 hours to form the copolymerized segment. The copolymerized polyimide includes 25% to 40% of the copolymerized segment, based on a total mole number of the copolymerized polyimide, to ensure better thermal properties.

As a solvent, dimethylacetamide (DMAc), N-methylpyrrolidone (NMP), N-ethyl-2-pyrrolidone (NEP), and γ-butyrolactone (GBL), and N,N-dimethylformamide (DMF), etc. can be used in the preparation of polyimide components. In an implementation aspect of the present disclosure, dimethylacetamide is used as the solvent.

After completing the polymerization of the copolymerized segment of BPDA and p-PDA, the remaining diamine is added. The diamine can be added in whole or in part to form a second copolymerized segment or a third copolymerized segment.

The diamine can be any one of mTB, ODA, and p-PDA. After the diamine is added, PMDA or BPDA is added to adjust the ratio of the total mole number of anhydride to the total mole number of diamine to above 0.95, and the reaction is carried out with stirring for at least 1 hr, preferably more than 2 hr. After that, a trace amount of BPDA or PMDA is used to adjust the viscosity, and finally the solution is adjusted to 100,000 cps˜600,000 cps, preferably 150,000˜400,000 cps. At this time, the solid content in the solution may be between 10˜25 wt %, and the preparation of a polyimide precursor is completed.

In addition, in the above-mentioned polyimide precursor, inorganic material particles or organic material particles may be added for the purpose of improving various characteristics such as winding properties, sliding properties, thermal conductivity, high hardness, color and luster, etc. The inorganic material particles may be silicon oxide, boron nitride, aluminum oxide, titanium oxide, zirconium oxide, zinc oxide, calcium phosphate, etc.

The organic material particles may be tetrafluoroethylene-perfluoroalkoxy vinyl ether copolymer (PFA), polytetrafluoroethylene (PTFE), liquid crystal polymer (LCP), polyimide (PI), etc.

The average particle size of inorganic material particles and organic material particles is usually between 0.01 um and 100 um, preferably 0.03 um and 10 um, and more preferably 0.05 um and 5 um.

The addition amount of inorganic material particles and organic material particles is 0.5˜10% by weight, preferably 1˜3% by weight, of the polyimide precursor.

For imidizing the above-mentioned polyimide precursor (copolymerized polyamic acid) to prepare the polyimide film, a thermal cyclization method and a chemical cyclization method can be used.

The thermal cyclization method is a cyclization method that does not use the dehydrating agent and the catalyst, in which copolymerized polyamic acid and the solvent is mixed, the viscosity is adjusted to 8,000˜20,000 cps for coating on a glass or metal carrier, the temperature is raised to a range between 350 and 400 degrees to perform baking for 1˜8 hours, thereby obtaining the polyimide film.

Regarding the chemical cyclization method, the copolymerized polyamic acid is mixed with a solvent to adjust the viscosity, and then a catalyst and a dehydrating agent are added to perform chemical cyclization, wherein the dehydrating agent may be acetic anhydride or benzoic anhydride. In the implementation aspects of the present disclosure, acetic anhydride is used as the dehydrating agent. The catalyst may be pyridine, 3-methylpyridine, 2-methylpyridine, 4-methylpyridine, isoquinoline, quinoline and triethylamine, among which the better choices are pyridine, 3-methylpyridine, 2-methylpyridine, 4-methylpyridine. In the implementation aspect of the present disclosure, 3-methylpyridine is selected as the catalyst.

The above-mentioned catalyst and dehydrating agent may be used alone or mixed with the solvent for dilution.

In the chemical cyclization method, after that, the dehydrating agent and the catalyst are added to the mixed solution of copolymerized polyamic acid and solvent, the mixed solution mixed with the dehydrating agent and the catalyst is evenly stirred and degassed using a centrifugal degasser, and the degassed solution is applied to a glass plate using a scraper. The gap of the scraper may be adjusted according to the required thickness. The coated sample is baked at 40° C.˜120° C. for 10˜40 minutes, preferably at 60° C.˜100° C. for 20˜30 minutes, then baked at 170° C.˜200° C. for 10 minutes, then baked at 230° C.˜280° C. for 5˜25 minutes, preferably at 240˜260° C. for 10˜20 minutes, and finally baked at 330° C.˜400° C. for 10˜30 minutes, preferably at 350° C.˜370° C. for 15˜20 minutes, as the final treatment.

In addition to glass, a metal plate may also be used as the substrate in the above-mentioned film forming process. When using the metal plate to make the polyimide film, after baking and drying in the temperature range of 40° C.˜120° C., the film needs to be removed from the metal plate, then the semi-dry film after removal is fixed on the metal frame, then the temperature is raised to 170° C. to perform baking for 20 minutes, and then the temperature is raised to 350° C. to perform baking for 20 minutes as the final treatment, thereby obtaining the polyimide film.

### Preparation of Laminate Board

The manufacturing method of the laminate board includes that a nickel metal layer is formed on a surface of the polyimide film by electroless plating so that the nickel metal layer is in contact with the polyimide film; and after forming the nickel metal layer, a thermal treatment is performed, and then a copper layer is formed thereon by electrolytic plating.

In an embodiment of the present disclosure, the nickel layer is a plating layer formed on one or both sides of the polyimide film by electroless plating. As for electroless plating, it can be a conventional electroless plating method and is not particularly limited. In addition, as a specific example of electroless plating, the polyimide film can also be surface hydrophilized first. Here, surface treatment commonly known in the art may be used, and there is no limitation here.

The surface treatment used in the present disclosure uses a roll-to-roll plasma treatment machine (Model No. R2RP03) purchased from Creating Nano Technologies Inc. to perform surface hydrophilization of the polyimide film. The operating conditions are described below.

The polyimide film is fixed on the unwinding reel and the guide film is connected thereto. The chamber is closed and nitrogen (N₂) is introduced therein. The power supply is turned on to start pumping, and the process section is entered after preheating is completed. The tension is set to 2 kg, the working pressure is 300 mTorr, the power is 10 KW, and the gas type and flow rate are adjusted. The gases include nitrogen (N₂), oxygen (O₂), carbon tetrafluoride (CF₄) and argon (Ar), which may be combined as required. The total gas flow rate may be controlled between 1900 sccm and 2700 sccm. The length of the plasma zone is 11 m. The processing time may be controlled by adjusting the linear speed of the machine, which may be range from 0.5 m/min to 6.0 m/min. After the process is completed, oxygen (O₂) and argon (Ar) are sequentially introduced to clean the chamber. After the vacuum is released, the power is turned off, and then the chamber is opened to take out the polyimide film, thereby completing the surface plasma modification.

The present disclosure refers to the SLP metallization process (SLP process) of Japan Okuno Pharmaceutical Co., Ltd., and uses the SLP series electroless nickel plating reagents to sequentially perform steps such as charge adjustment, pre-soaking, catalysis, acceleration, and reduction nickel plating. Operating conditions are described below.

The hydrophilized PI film is soaked in an SLP-200 solution at 65° C. for 75 seconds for charge adjustment, taken out and washed with water.

The PI film is sequentially soaked in an SLP-300 solution at 25° C. for 25 seconds and an SLP-400 solution for 75 seconds to make the catalyst (for example, palladium) adhere to the surface of the PI film, taken out and washed with water.

Next, the PI film is soaked in an SLP-500 solution at 35° C. for 75 seconds to activate the catalyst, taken out and washed with water.

Finally, the PI film is soaked in an SLP-660 solution at 40° C., the pH value is controlled to 8.5±0.1, the reduction nickel plating reaction is performed for 250 seconds, and the PI film is taken out and washed with water to complete a composite film of the nickel metal layer/polyimide film, and a thickness of the single-sided nickel layer is between 0.08 and 0.10 μm.

The copper layer of the present disclosure is not particularly limited, as long as it is a copper layer that can form subsequently etched circuits. Moreover, in one embodiment of the present disclosure, it is preferable to use electroplating to plate the copper layer on the nickel metal layer. As for the electroplating solution used for the copper layer, it can be a commercial product, for example, a copper sulfate electroplating liquid (purchased from Jiwei Industrial Co., Ltd.) and the like.

The operating conditions for electroplating copper layers are described below. The composite film of the aforementioned nickel metal layer/polyimide film is first heat-treated and baked at 120° C. for 24 hours, and then 2 wt % sulfuric acid is used to remove the oxide layer on the surface of the nickel metal layer, and then electrolytic plating is performed in an electroplating tank. The electroplating solution contains 150 g/L sulfuric acid, 120 g/L copper sulfate and 50 ppm chloride ions, as well as an appropriate amount of electroplating additives, such as a gloss agent, a flattening agent, etc. The current density is 4 A/dm², and the average plating speed is about 0.5 μm/min. The power-on time is controlled to deposit a copper metal layer with a thickness of 0.2˜20 μm on the surface of the nickel layer as required.

### EXAMPLES

### <Detection Method>

The thermal properties and electrical properties of the polyimide films obtained in the following examples are measured using the following methods.
(1) Young's modulus: Measured according to the ASTM D882 standard specification using a Hounsfield H10K-S tensile machine.
(2) Linear coefficient of thermal expansion CTE: Measured according to the ASTM D696 specifications using TA Instruments' model Q400 TMA instrument. The coefficient of thermal expansion of the polyimide film is measured at 50˜200° C., and the heating rate is set to 10° C./min. In order to remove the stress caused by heat treatment, after removing the residual stress through the first measurement, the second measurement result is used as the actual value.
(3) Adhesive force: Measured according to the IPC-TM-6502.4.9 standard specification using a Hounsfield H10K-S tensile machine.
(4) Calculation of the molar ratio of the dianhydride and diamine in the copolymerized segment: After the molar numbers of the diamine and the diamine in the copolymerized segment solution are calculated respectively, the molar number of the diamine is divided by the molar number of the diamine to obtain the molar ratio of the dianhydride and diamine in the copolymerized segment.
(5) Calculation of the molar ratio of the copolymerized segment in the polyimide: The molar numbers of the diamine and the diamine in the copolymerized segment solution are calculated respectively and added together, and then divided by the total molar number of the copolymerized polyimide solution to obtain the molar ratio of the copolymerized segment in the whole polyimide.

### Example 1

### Preparation of Polyimide Film

7.139 g of p-phenylenediamine (p-PDA, 0.066 mole) was added to 400 g of N,N-dimethylacetamide (DMAc). After complete dissolution, 15.538 g of 3,3′,4, 4′-biphenyltetracarboxylic dianhydride (BPDA, 0.165 mole) was added, stirred and reacted for 1 hr while maintaining the temperature at 25° C. to form a copolymerized segment solution.

25.694 g of 2,2′-dimethyl-4,4′-diaminobiphenyl (m-TB, 0.121 mole) was added to the above copolymerized segment solution and stirred until complete dissolution. After that, 11.999 g of pyromellitic anhydride (PMDA, 0.055 mole) was added slowly and stirred for 0.5 hr for dissolution and reaction, and the temperature of the solution was maintained at 25° C. After that, 12.301 g of BPDA was added and reacted for 1 hr. Next, 6.609 g of ODA (0.033 mol) was added until complete dissolution and then 19.747 g of BPDA (0.0671 mol) was added, stirred and reacted for 2 hr. After that, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.12 grams of acetic anhydride diluent (the weight ratio of acetic anhydride and DMAc being 5 to 1) and 5.41 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board

A nickel metal layer was formed on the surface of the polyimide film by electroless plating, so that the nickel metal layer was in contact with the polyimide film; and after the nickel metal layer was formed, heat treatment was performed, and then a copper layer was formed thereon by electrolytic plating.

In this embodiment, the nickel layer was a plating layer formed on one or both sides of the polyimide film by electroless plating. As for the electroless plating, it may be the above-mentioned electroless plating method.

In this embodiment, the nickel layer was a plating layer formed on one or both sides of the polyimide film by electroless plating. This embodiment referred to the SLP metallization process (SLP process) of Japan Okuno Pharmaceutical Co., Ltd. and used the SLP series electroless nickel plating reagents to sequentially perform steps such as charge adjustment, pre-soaking, catalysis, acceleration, and reduction nickel plating. The operating conditions were as described above.

The manufacturing conditions of the copper layer in this embodiment were also as described above. In this way, a laminate board of copper layer/nickel metal layer/polyimide film may be obtained, the thickness of the nickel metal layer on one side was 0.08˜0.10 μm, and the thickness of the copper layer on one side was 0.2˜20 μm.

### Example 2

### Preparation of Polyimide Film

7.167 g of p-phenylenediamine (p-PDA, 0.0663 mole) was added to 400 g of N, N-dimethylacetamide (DMAc). After complete dissolution, 17.551 g of 3,3′,4, 4′-biphenyltetracarboxylic dianhydride (BPDA, 0.165 mole) was added, stirred and reacted for 1 hr while maintaining the temperature at 25° C. to form a copolymerized segment solution.

18.762 g of 2,2′-dimethyl-4,4′-diaminobiphenyl (m-TB, 0.088 mole) was added to the above copolymerized segment solution and stirred until complete dissolution. After that, 12.047 g of pyromellitic anhydride (PMDA, 0.055 mole) was added slowly and stirred for 0.5 hr for dissolution and reaction, and the temperature of the solution was maintained at 25° C. After that, 7.150 g of BPDA was added and reacted for 1 hr. Next, 13.272 g of 4,4′-oxydianiline (ODA, 0.066 mol) was added until complete dissolution and then 23.076 g of BPDA (0.0784 mol) was added, stirred and reacted for 2 hr. After that, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.15 grams of acetic anhydride diluent (the weight ratio of acetic anhydride and DMAc being 5 to 1) and 5.43 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Example 3

### Preparation of Polyimide Film

7.167 g of p-phenylenediamine (p-PDA, 0.0663 mole) was added to 400 g of N, N-dimethylacetamide (DMAc). After complete dissolution, 18.526 g of 3,3′,4, 4′-biphenyltetracarboxylic dianhydride (BPDA, 0.0552 mole) was added, stirred and reacted for 1 hr while maintaining the temperature at 25° C. to form a copolymerized segment solution.

18.762 g of 2,2′-dimethyl-4,4′-diaminobiphenyl (m-TB, 0.0884 mole) was added to the above copolymerized segment solution and stirred until complete dissolution. After that, 12.047 g of pyromellitic anhydride (PMDA, 0.0552 mole) and 8.45 g of BPDA were added slowly and stirred for 1 hr, then 13.272 g of 4,4′-oxydianiline (ODA, 0.0663 mol) was added until complete dissolution, then 20.801 g of BPDA (0.0707 mole) was added slowly and stirred for 12 hr for dissolution and reaction, and the temperature of the solution was maintained at 25° C. After that, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.15 grams of acetic anhydride diluent (the weight ratio of acetic anhydride and DMAc being 5 to 1) and 5.43 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 20 minutes, then the temperature was raised to 170° C. at a rate of 1.8° C./min to perform baking for 20 minutes, and then the temperature was raised to 350° C. at a rate of 2.0° C./min to perform baking for 20 minutes as the final treatment.

### Preparation of Laminate Board: The Same as Example 1.

### Example 4

### Preparation of Polyimide Film

7.228 g of p-phenylenediamine (p-PDA, 0.0668 mole) was added to 400 g of N,N-dimethylacetamide (DMAc). After complete dissolution, 18.683 g of 3,3′,4, 4′-biphenyltetracarboxylic dianhydride (BPDA, 0.0635 mole) was added, stirred and reacted for 1 hr while maintaining the temperature at 25° C. to form a copolymerized segment solution.

18.921 g of 2,2′-dimethyl-4,4′-diaminobiphenyl (m-TB, 0.209 mole) was added to the above copolymerized segment solution and stirred until complete dissolution. After that, 14.579 g of pyromellitic anhydride (PMDA, 0.0668 mole) was added slowly and stirred for 0.5 hr for dissolution and reaction, and the temperature of the solution was maintained at 25° C. After that, 5.244 g of BPDA was added and reacted for 1 hr. Next, 13.384 g of 4,4′-oxydianiline (ODA, 0.0668 mol) was added until complete dissolution and then 20.977 g of BPDA (0.0713 mol) was added, stirred and reacted for 2 hr. After that, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.21 grams of acetic anhydride diluent (the weight ratio of acetic anhydride and DMAc being 5 to 1) and 5.48 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Example 5

### Preparation of Polyimide Film: The Same as Example 4.

Preparation of laminate board: The polyimide film was subject to surface plasma modification. The polyimide film was fixed on the unwinding reel and the guide film was connected thereto. The tension was set to 2 kg, the working pressure was 300 mTorr, the power was 10 kW, and the flow rate of nitrogen gas was adjusted to 2000 sccm. The length of the plasma zone was 11 m. The linear speed was 5.0 m/min. After the process was completed, oxygen (O₂) and argon (Ar) were sequentially introduced to clean the chamber. After the vacuum was released, the power was turned off, and then the chamber was opened to take out the polyimide film, thereby completing the surface plasma modification. The following steps were the same as Example 1.

### Example 6

### Preparation of Polyimide Film

7.290 g of p-phenylenediamine (p-PDA, 0.0674 mole) was added to 400 g of N,N-dimethylacetamide (DMAc). After complete dissolution, 18.842 g of 3,3′,4, 4′-biphenyltetracarboxylic dianhydride (BPDA, 0.064 mole) was added, stirred and reacted for 1 hr while maintaining the temperature at 25° C. to form a copolymerized segment solution.

19.082 g of 2,2′-dimethyl-4,4′-diaminobiphenyl (m-TB, 0.0899 mole) was added to the above copolymerized segment solution and stirred until complete dissolution. After that, 17.155 g of pyromellitic anhydride (PMDA, 0.0786 mole) was added slowly and stirred for 0.5 hr for dissolution and reaction, and the temperature of the solution was maintained at 25° C. After that, 1.983 g of BPDA was added and reacted for 0.5 hr. Next, 13.499 g of 4,4′-oxydianiline (ODA, 0.0674 mol) was added until complete dissolution and then 21.156 g of BPDA (0.0719 mol) was added, stirred and reacted for 2 hr. After that, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.27 grams of acetic anhydride diluent (the weight ratio of acetic anhydride and DMAc being 5 to 1) and 5.52 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Example 7

### Preparation of Polyimide Film: The Same as Example 6.

### Preparation of Laminate Board: The Same as Example 5.

### Example 8

### Preparation of Polyimide Film: The Same as Example 6.

Preparation of laminate board: The polyimide film was subject to surface plasma modification. The polyimide film was fixed on the unwinding reel and the guide film was connected thereto. The tension was set to 2 kg, the working pressure was 300 mTorr, the power was 10 KW, and the flow rate of argon (Ar) was adjusted to 2000 sccm. The length of the plasma zone was 11 m. The linear speed was 5.0 m/min. After the process was completed, oxygen (O₂) and argon (Ar) were sequentially introduced to clean the chamber. After the vacuum was released, the power was turned off, and then the chamber was opened to take out the polyimide film, thereby completing the surface plasma modification. The following steps were the same as Example 1.

### Example 9

### Preparation of Polyimide Film

9.925 g of p-phenylenediamine (p-PDA, 0.0918 mole) was added to 400 g of N,N-dimethylacetamide (DMAc). After complete dissolution, 24.304 g of 3,3′,4, 4′-biphenyltetracarboxylic dianhydride (BPDA, 0.0826 mole) was added, stirred and reacted for 2 hr while maintaining the temperature at 25° C. to form a copolymerized segment solution.

19.486 g of 2,2′-dimethyl-4,4′-diaminobiphenyl (m-TB, 0.0918 mole) was added to the above copolymerized segment solution and stirred until complete dissolution. After that, 17.517 g of pyromellitic anhydride (PMDA, 0.0803 mole) was added slowly and stirred for 1 hr for dissolution and reaction, and the temperature of the solution was maintained at 25° C. Next, 9.189 g of 4,4′-oxydianiline (ODA, 0.0459 mol) was added until complete dissolution and then 18.566 g of BPDA (0.0631 mol) was added, stirred and reacted for 2 hr. After that, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.42 grams of acetic anhydride diluent (the weight ratio of acetic anhydride and DMAc being 5 to 1) and 5.64 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Comparative Example 1

### Preparation of Polyimide Film

11.090 g of p-phenylenediamine (p-PDA, 0.1025 mole) was added to 400 g of N,N-dimethylacetamide (DMAc). After complete dissolution, 24.138 g of 3,3′,4, 4′-biphenyltetracarboxylic dianhydride (BPDA, 0.082 mole) was added, stirred and reacted for 1 hr while maintaining the temperature at 25° C. to form a copolymerized segment solution.

19.352 g of 2,2′-dimethyl-4,4′-diaminobiphenyl (m-TB, 0.0912 mole) was added to the above copolymerized segment solution and stirred until complete dissolution. After that, 12.427 g of pyromellitic anhydride (PMDA, 0.057 mole) was added slowly and stirred for 0.5 hr for dissolution and reaction, and the temperature of the solution was maintained at 25° C. Next, 6.845 g of 4,4′-oxydianiline (ODA, 0.0342 mol) was added until complete dissolution and then 25.143 g of BPDA (0.0855 mol) was added, stirred and reacted for 2 hr. After that, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.37 grams of acetic anhydride diluent (the weight ratio of acetic anhydride and DMAc being 5 to 1) and 5.6 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Comparative Example 2

### Preparation of Polyimide Film

7.167 g of p-phenylenediamine (p-PDA, 0.0663 mole) was added to 400 g of N,N-dimethylacetamide (DMAc). After complete dissolution, 11.565 g of pyromellitic dianhydride (PMDA, 0.0530 mole) was added, stirred and reacted for 1 hr while maintaining the temperature at 25° C. to form a copolymerized segment solution.

18.762 g of 2,2′-dimethyl-4,4′-diaminobiphenyl (m-TB, 0.0884 mole) was added to the above copolymerized segment solution and stirred until complete dissolution. After that, 0.482 g of pyromellitic anhydride (PMDA, 0.0786 mole) and 20.151 g of 3,3′,4,4′-biphenyltetracarboxylic dianhydride (BPDA, 0.0685 mole) were added slowly and stirred for 0.5 hr for dissolution and reaction, and the temperature of the solution was maintained at 25° C. Next, 13.272 g of 4,4′-oxydianiline (ODA, 0.0663 mol) was added until complete dissolution and then 27.626 g of BPDA (0.0939 mol) was added, stirred and reacted for 2 hr. After that, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.15 grams of acetic anhydride diluent (the weight ratio of acetic anhydride and DMAc being 5 to 1) and 5.43 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Comparative Example 3

### Preparation of Polyimide Film

13.272 g of 4,4′-oxydianiline (ODA, 0.0663 mole) was added to 400 g of N,N-dimethylacetamide (DMAc). After complete dissolution, 11.565 g of pyromellitic dianhydride (PMDA, 0.0393 mole) was added, stirred and reacted for 1 hr while maintaining the temperature at 25° C. to form a copolymerized segment solution.

18.762 g of 2,2′-dimethyl-4,4′-diaminobiphenyl (m-TB, 0.0884 mole) was added to the above copolymerized segment solution and stirred until complete dissolution. After that, 0.482 g of pyromellitic anhydride (PMDA, 0.0022 mole) and 20.801 g of 3,3′,4,4′-biphenyltetracarboxylic dianhydride (BPDA, 0.0707 mole) were added slowly and stirred for 0.5 hr for dissolution and reaction, and the temperature of the solution was maintained at 25° C. Next, 7.167 g of phenylenediamine (p-PDA, 0.0663 mol) was added until complete dissolution and then 26.976 g of BPDA (0.0917 mol) was added, stirred and reacted for 2 hr. After that, a trace amount of BPDA was used to adjust the viscosity to 250,000±300,000 cps, and finally a copolymerized polyamic acid solution having a solid content of 20% was obtained. 33 g of the above-mentioned copolymerized polyamic acid solution was taken out, and 17 g of N, N-dimethylacetamide (DMAc) was added therein to dilute the solid content to 13.2%. After stirring for 10 minutes, 7.15 grams of acetic anhydride diluent (the weight ratio of acetic anhydride and DMAc being 5 to 1) and 5.43 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Comparative Example 4

### Preparation of Polyimide Film

13.272 g of 4,4′-oxydianiline (ODA, 0.0663 mole) was added to 400 g of N,N-dimethylacetamide (DMAc). After complete dissolution, 15.601 g of 3,3′,4, 4′-biphenyltetracarboxylic dianhydride (BPDA, 0.0530 mole) was added, stirred and reacted for 1 hr while maintaining the temperature at 25° C. to form a copolymerized segment solution.

18.762 g of 2,2′-dimethyl-4,4′-diaminobiphenyl (m-TB, 0.0884 mole) was added to the above copolymerized segment solution and stirred until complete dissolution. After that, 12.047 g of pyromellitic anhydride (PMDA, 0.0552 mole) and 4.550 g of 3,3′,4,4′-biphenyltetracarboxylic dianhydride (BPDA, 0.0155 mole) were added slowly and stirred for 0.5 hr for dissolution and reaction, and the temperature of the solution was maintained at 25° C. Next, 7.167 g of phenylenediamine (p-PDA, 0.0552 mol) was added until complete dissolution and then 27.626 g of BPDA (0.0939 mol) was added, stirred and reacted for 2 hr. After that, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.15 grams of acetic anhydride diluent (the weight ratio of acetic anhydride and DMAc being 5 to 1) and 5.43 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Comparative Example 5

### Preparation of Polyimide Film

12.985 g of phenylenediamine (PDA, 0.120 mole) was added to 400 g of N,N-dimethylacetamide (DMAc). After complete dissolution, 31.797 g of 3,3′,4, 4′-biphenyltetracarboxylic dianhydride (BPDA, 0.1081 mole) was added, stirred and reacted for 2 hr while maintaining the temperature at 25° C. to form a copolymerized segment solution.

25.493 g of 2,2′-dimethyl-4,4′-diaminobiphenyl (m-TB, 0.120 mole) was added to the above copolymerized segment solution and stirred until complete dissolution. After that, 26.192 g of pyromellitic anhydride (PMDA, 0.120 mole) and 2.473 g of 3,3′,4,4′-biphenyltetracarboxylic dianhydride (BPDA, 0.0084 mole) were added slowly and stirred for 0.5 hr for dissolution and reaction, and the temperature of the solution was maintained at 25° C. After stirring and reaction for 2 hr, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.77 grams of acetic anhydride diluent (the weight ratio of acetic anhydride and DMAc being 5 to 1) and 5.90 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Comparative Example 6

### Preparation of Polyimide Film

25.493 g of 2,2′-dimethyl-4,4′-diaminobiphenyl (m-TB, 0.120 mole) was added to 400 g of N,N-dimethylacetamide (DMAc). After complete dissolution, 31.797 g of 3,3′, 4, 4′-biphenyltetracarboxylic dianhydride (BPDA, 0.1081 mole) was added, stirred and reacted for 2 hr while maintaining the temperature at 25° C. to form a copolymerized segment solution.

12.985 g of phenylenediamine (PDA, 0.120 mole) was added to the above copolymerized segment solution and stirred until complete dissolution. After that, 26.192 g of pyromellitic anhydride (PMDA, 0.120 mole) and 2.473 g of 3,3′,4,4′-biphenyltetracarboxylic dianhydride (BPDA, 0.0084 mole) were added slowly and stirred for 0.5 hr for dissolution and reaction, and the temperature of the solution was maintained at 25° C. After stirring and reaction for 2 hr, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.77 grams of acetic anhydride diluent (the weight ratio of acetic anhydride and DMAc being 5 to 1) and 5.90 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Comparative Example 7

### Preparation of Polyimide Film

22.954 g of 2,2′-dimethyl-4,4′-diaminobiphenyl (m-TB, 0.108 mole) was added to 400 g of N,N-dimethylacetamide (DMAc). After complete dissolution, 28.631 g of 3,3′,4, 4′-biphenyltetracarboxylic dianhydride (BPDA, 0.108 mole) was added, stirred and reacted for 2 hr while maintaining the temperature at 25° C. to form a copolymerized segment solution.

21.650 g of 4,4′-oxydianiline (ODA, 0.0108 mole) was added to the above copolymerized segment solution and stirred until complete dissolution. After that, 23.584 g of pyromellitic anhydride (PMDA, 0.108 mole) and 2.227 g of 3,3′,4,4′-biphenyltetracarboxylic dianhydride (BPDA, 0.0076 mole) were added slowly and stirred for 0.5 hr for dissolution and reaction, and the temperature of the solution was maintained at 25° C. After stirring and reaction for 2 hr, a trace amount of BPDA was used to adjust the viscosity to 250,000±300,000 cps, and finally a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 6.99 grams of acetic anhydride diluent (the weight ratio of acetic anhydride and DMAc being 5 to 1) and 5.32 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

### Comparative Example 8

### Preparation of Polyimide Film

4.860 g of p-phenylenediamine (p-PDA, 0.0449 mole) was added to 400 g of N,N-dimethylacetamide (DMAc). After complete dissolution, 11.901 g of 3,3′,4, 4′-biphenyltetracarboxylic dianhydride (BPDA, 0.0404 mole) was added, stirred and reacted for 1 hr while maintaining the temperature at 25° C. to form a copolymerized segment solution.

19.082 g of 2,2′-dimethyl-4,4′-diaminobiphenyl (m-TB), 0.0899 mole) and 2.430 g of p-phenylenediamine (0.0225 mole) were added to the above copolymerized segment solution and stirred until complete dissolution. After that, 17.155 g of pyromellitic anhydride (PMDA, 0.0786 mole) and 6.611 g of 3,3′,4,4′-biphenyltetracarboxylic dianhydride (BPDA, 0.0225 mole) were added slowly and stirred for 1 hr for reaction. After that, 13.499 g of 4,4′-oxydianiline (ODA, 0.0674 mol) was added until complete dissolution, then 23.470 g of BPDA (0.0798 mol) was added, stirred and reacted for 2 hr, and the temperature of the solution was maintained at 25° C. Finally, a trace amount of BPDA was used to adjust the viscosity to 250,000±300,000 cps, and a copolymerized polyamic acid solution having a solid content of 20% was obtained.

33 g of the above-mentioned copolymerized polyamic acid solution was taken out, and 17 g of N, N-dimethylacetamide (DMAc) was added therein to dilute the solid content to 13.2%. After stirring for 10 minutes, 7.27 grams of acetic anhydride diluent (the weight ratio of acetic anhydride and DMAc being 5 to 1) and 5.52 grams of 3-methylpyridine diluent (the weight ratio of 3-methylpyridine and DMAc being 1:1) were added to the diluted copolymerized polyamic acid solution respectively. After evenly stirring, a centrifugal degassing machine was used for degassing, the degassed solution was applied to the glass plate, and then a scraper was used with a gap of 600 μm for coating. The coated sample was placed in an oven and baked at 80° C. for 40 minutes, then the temperature was raised to 170° C. at a rate of 3.6° C./min to perform baking for 10 minutes, and then the temperature was raised to 260° C. at a rate of 5.9° C./min to perform baking for 10 minutes. Finally, the temperature was raised to 350° C. at a rate of 8.13° C./min to perform baking for 20 minutes as the final treatment.

### Preparation of Laminate Board: The Same as Example 1.

Finally, the compositions used in the above Examples and Comparative Examples and the physical properties of the obtained polyimide films are summarized in Table 1 below.

TABLE 1

| | | | | | | | | molar ratio of |
|---|---|---|---|---|---|---|---|---|
| | | | | | | | | copolymerized |
| | | | | | | Plasma | | segment in |
| | Formulation (mol %) | | | | | surface | Copolymerized | polyimide |
| | PMDA | BPDA | p-PDA | ODA | m-TB | treatment | segment | mol % |
| Example 1 | 25 | 75 | 30 | 15 | 55 | — | BPDA/PDA | 27 |
| Example 2 | 25 | 75 | 30 | 30 | 40 | — | BPDA/PDA | 28.5 |
| Example 3 | 25 | 75 | 30 | 30 | 40 | — | BPDA/PDA | 29.3 |
| Example 4 | 30 | 70 | 30 | 30 | 40 | — | BPDA/PDA | 29.3 |
| Example 5 | 30 | 70 | 30 | 30 | 40 | N₂ | BPDA/PDA | 29.3 |
| Example 6 | 35 | 65 | 30 | 30 | 40 | — | BPDA/PDA | 29.3 |
| Example 7 | 35 | 65 | 30 | 30 | 40 | N₂ | BPDA/PDA | 29.3 |
| Example 8 | 35 | 65 | 30 | 30 | 40 | Ar | BPDA/PDA | 29.3 |
| Example 9 | 35 | 65 | 40 | 20 | 40 | — | BPDA/PDA | 38 |
| Comparative | 25 | 75 | 45 | 15 | 40 | — | BPDA/PDA | 40.5 |
| Example 1 | | | | | | | | |
| Comparative | 25 | 75 | 30 | 30 | 40 | — | PMDA/PDA | 27 |
| Example 2 | | | | | | | | |
| Comparative | 25 | 75 | 30 | 30 | 40 | — | PMDA/ODA | 27.5 |
| Example 3 | | | | | | | | |
| Comparative | 25 | 75 | 30 | 30 | 40 | — | BPDA/ODA | 27.5 |
| Example 4 | | | | | | | | |
| Comparative | 50 | 50 | 50 | 0 | 50 | — | BPDA/PDA | 47.5 |
| Example 5 | | | | | | | | |
| Comparative | 50 | 50 | 50 | 0 | 50 | — | BPDA/mTB | 47.5 |
| Example 6 | | | | | | | | |
| Comparative | 50 | 50 | 0 | 50 | 50 | — | BPDA/mTB | 47.5 |
| Example 7 | | | | | | | | |
| Comparative | 35 | 65 | 30 | 30 | 40 | — | BPDA/PDA | 19 |
| Example 8 | | | | | | | | |

| | molar ratio of | | Adhesive | | |
|---|---|---|---|---|---|
| | dianhydride | | force after | | |
| | to diamine in | Adhesive | being at 150° | | Young's |
| | copolymerized | force | C. for 24 hr | CTE | modulus |
| | segment | kgf/cm | kgf/cm | ppm/° C. | GPa |
| Example 1 | 0.80 | 0.69 | 0.57 | 14.7 | 7.1 |
| Example 2 | 0.90 | 0.73 | 0.59 | 12.6 | 7.3 |
| Example 3 | 0.95 | 0.70 | 0.61 | 11.8 | 7.5 |
| Example 4 | 0.95 | 0.67 | 0.52 | 6.4 | 8.0 |
| Example 5 | 0.95 | 0.82 | 0.63 | — | — |
| Example 6 | 0.95 | 0.70 | 0.55 | 4.6 | 8.0 |
| Example 7 | 0.95 | 1.00 | 0.93 | — | — |
| Example 8 | 0.95 | 0.97 | 0.82 | — | — |
| Example 9 | 0.90 | 0.66 | 0.52 | 4.1 | 8.2 |
| Comparative | 0.80 | 0.39 | 0.53 | 10.3 | 8.1 |
| Example 1 | | | | | |
| Comparative | 0.80 | 0.69 | 0.45 | 8.3 | 7.4 |
| Example 2 | | | | | |
| Comparative | 0.83 | 0.84 | 0.68 | 13.7 | 5.4 |
| Example 3 | | | | | |
| Comparative | 0.83 | 0.88 | 0.81 | 20.8 | 6.7 |
| Example 4 | | | | | |
| Comparative | 0.95 | 0.06 | 0.04 | 0.10 | 9.4 |
| Example 5 | | | | | |
| Comparative | 0.95 | 0.06 | 0.06 | 1.20 | 10.4 |
| Example 6 | | | | | |
| Comparative | 0.95 | 0.70 | 0.50 | 24.0 | 6.0 |
| Example 7 | | | | | |
| Comparative | 0.90 | 0.68 | 0.52 | 13.4 | 6.8 |
| Example 8 | | | | | |

First, as shown in the above Table 1, because the content of p-phenylenediamine and the content of the copolymerized segment in the polyimide in Comparative Example 1 are not within the desired range of the present application, it can be seen that the numerical value of the adhesive force is too low to meet the needs.

Secondly, as shown in the above Table 1, because Comparative Example 2 does not have the copolymerized segment composed of BPDA and p-PDA, it can be seen that the value of the adhesive force after baking is too low to meet the requirements.

Furthermore, as shown in Table 1 above, because Comparative Example 3 does not have the copolymerized segment composed of BPDA and p-PDA, it can be seen that its value of Young's modulus is too low to meet the requirements.

Next, as shown in Table 1 above, because Comparative Example 4 does not have the copolymerized segment composed of BPDA and p-PDA, it can be seen that its coefficient of thermal expansion CTE is on the high side, and its value of Young's modulus is on the low side, which does not meet the needs.

Then, as shown in Table 1 above, because Comparative Example 5 does not have the specific composition ratio of dianhydride and diamine required by the present disclosure, it can be seen that its adhesive strength value is too low to meet the requirements.

In addition, as shown in Table 1 above, because Comparative Example 6 has neither the specific composition ratio of dianhydride and diamine of the present disclosure, nor the copolymerized segment composed of BPDA and p-PDA, it can be seen that its value of adhesive force is too low to meet the requirements.

On the other hand, as shown in Table 1 above, because Comparative Example 7 has neither the specific composition ratio of dianhydride and diamine of the present disclosure, nor the copolymerized segment composed of BPDA and p-PDA, it can be seen that its value of adhesive force is low, coefficient of thermal expansion CTE is high, and value of Young's modulus is low, which does not meet the needs.

In addition, as shown in Table 1 above, because the content of the copolymerized segment in the polyimide of Comparative Example 8 is not within the desired range of the present application, it can be seen that its value of Young's modulus is low and does not meet the requirements.

The content of the above specific embodiments is to illustrate the present invention in detail. However, these embodiments are only for illustration and are not intended to limit the present invention. Those skilled in the art will understand that various changes or modifications made to the present invention without departing from the scope defined in the appended claims are part of the present invention.

While the present disclosure has been described by means of specific embodiments, numerous modifications and variations could be made thereto by those skilled in the art without departing from the scope and spirit of the present disclosure set forth in the claims.

What is claimed is:

1. A polyimide film, comprising a copolymerized polyimide formed from a dianhydride and a diamine, the dianhydride comprising 60 to 80 mol % of 3,3′,4,4′-biphenyltetracarboxylic dianhydride (BPDA) and 20 to 40 mol % of pyromellitic dianhydride (PMDA), based on a total mole number of the dianhydride; the diamine comprising 10 to 40 mol % of p-phenylenediamine (p-PDA), 30 to 60 mol % of 2,2′-dimethyl-4,4′-diaminobiphenyl (m-TB), and 10 to 40 mol % of 4,4′-oxydianiline (ODA), based on a total mole number of the diamine; wherein the copolymerized polyimide comprises 25 to 40% of a copolymerized segment composed of 3,3′,4,4′-biphenyltetracarboxylic dianhydride (BPDA) and p-phenylenediamine (p-PDA), based on a total mole number of the copolymerized polyimide; and the polyimide film has a linear coefficient of thermal expansion CTE of less than 15 ppm/° C. and a Young's modulus of greater than 7 GPa.

2. The polyimide film of claim 1, wherein a molar ratio of the dianhydride to the diamine in the copolymerized segment is greater than 0.9.

3. The polyimide film of claim 1, wherein the polyimide film is made by a chemical cyclization method with a baking temperature between 350° C. and 380° C.

4. A laminate board, comprising a polyimide film of claim 1 and a metal layer attached to the polyimide film, an adhesive force between the metal layer and the polyimide film is greater than 0.65 Kgf/cm, and the adhesive force between the metal layer and the polyimide film is greater than 0.5 Kgf/cm after baking at 150° C. for 24 hr.

5. The laminate board of claim 4, wherein the polyimide film is surface treated using plasma so that the adhesive force between the metal layer and the polyimide film is greater than 0.8 Kgf/cm.

6. The laminate board of claim 5, wherein the plasma is atmospheric plasma and uses at least one gas selected from the group consisting of nitrogen, argon, oxygen and carbon tetrafluoride.
